(19) United States
(12) Patent Application Publication
(10) Pub. No.: US 2007/0079375 A1
(43) Pub. Date: Apr. 5, 2007

(54) Computer Behavioral Management Using Heuristic Analysis

(76) Inventor: Drew Copley, Aliso Viejo, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/537,900

(22) Filed: Oct. 2, 2006

Related U.S. Application Data
(60) Provisional application No. 60/723,726, filed on Oct. 4, 2005.

(51) Int. Cl. G06F 12/14

(52) U.S. Cl. 726/22

(57) ABSTRACT

In accordance with an embodiment of the present invention, a method of managing computer process execution may include selecting a computer file prior to execution of the computer file, analyzing the selected computer file to determine at least one executable behavior, identifying the analyzed computer file as one of harmful or harmless, and disposing of the identified computer file as one of executable or non-executable, where the selected computer file is disposed as non-executable when the selected file is identified as harmful.

### CROSS-REFERENCE TO RELATED APPLICATION

This application relies for priority upon a Provisional Patent Application No. 60/723,726 filed in the United States Patent and Trademark Office, on Oct. 4, 2005, the entire content of which is incorporated by reference.

### TECHNICAL FIELD

The present invention relates to computer systems, and more particularly to behavioral management of computer processes.

### BACKGROUND

The proliferation of computer viruses and other malevolent software (malware) has increased dramatically in recent years. A primary fault of traditional anti-virus software has been that generally it has relied almost exclusively on the detection of static, binary signatures. Generic attempts to protect against both known and unknown malicious files have included the use of an “API Firewall” or an “Application Firewall”. Such systems are typically designed to hook into the underlying Operating System so that when behaviors are called by an executing process those behaviors are then compared against a database of rules, in a variety of ways, to determine whether or not such a file should be allowed to run. Application Firewalls generally operate in a network environment by examining server and client process calls.

Firewall systems tend to introduce a large number of false positives, or false alarms, which then may have to be manually examined by a human operator. This manual step introduces the possibility that true alarms may escape detection because of the proliferation of false alarms. Further, systems that perform anti-malicious related activities such as logging often introduce corrective or preventive measures against legitimate file execution. While sorting through the false alarms, the sudden consumption of system resources, such as central processing unit (CPU) and memory bandwidth, can also introduce a wide range of problems including increased response time, halting of important services, interruption to essential services, and so forth. In spite of the high cost of detection by a firewall system, there are several ways malicious executables may evade an active inspection. For example, a malicious executable may perform certain operations that access non-traditional APIs and bypass the regular APIs entirely. In this manner, the malicious executables will not be stopped by the firewall since all of these systems operate after the offending process has already been executed.

Another attempt to protect against unknown malicious files includes the underlying Access Control System of the OS itself, as defined by the Department of Defense (DoD) publication “Trusted Computer System Evaluation Criteria”, also known as the “Orange Book Standard”. In fact, a “Privilege Management System” (PMS) and a Access Control System (ACS) are largely synonymous, with the exception that an ACS implies, by DoD definition, a more abstract control system then the level at which the BMS operates. The BMS is not an Access Control System, but rather it is designed to complement a type of Access Control System called a “Discretionary Access Control” (DAC) System, in contrast to a Mandatory Access Control (MAC) framework. In a DAC system, any user with access can propagate information. In a MAC system, an administrator can restrict propagation. Most modern Operating Systems are rated as DAC systems, which means that a user can adjust the level of access on the system, as opposed to a system where access is granted or denied apart from the granular user. In a more secure OS, you may see a MAC system employed. In these systems, the user cannot define how some resources or information might be accessed.

In the BMS, the OS underlying the Access Control System is typically modified to include new capabilities at a more granular level. For example, a DAC system can utilize Access Control Lists (ACLs) that apply to objects on a system and which define access by user for that object. These types of behaviors may therefore be defined, for instance: to Read, Write, Create, Execute, Modify, Delete, and/or Rename. The BMS may include an additional layer which may be activated on a mandatory level. This provides all users, as so defined by the System though editable on an administrative level, the further granularity to ensure that an application which has the capability, for instance, to access a remote resource on a network device may not be run. The BMS need not, therefore, stop an application from performing this action when it attempts to do so. Instead, the BMS may stop the application from running in the first place because it was ascertained that it has this inherent capability within itself to do this. The motivation for this is because in such a Discretionary System many attacks are possible which allow for the “discretion” of the user to be surmounted by a malicious process improperly taking control of privileges it should not have control of. Further, a corrupt user may use their advanced discretion to subvert the underlying system. The BMS provides a level of dynamic, mandatory access control to the OS without forcing the whole system into a MAC type system which is highly user unfriendly and primarily designed for classified systems.

### SUMMARY

Apparatuses, systems, and methods are disclosed herein which may provide management of potentially harmful computer processes in an intelligent, efficient, and cost-effective manner.

In accordance with an embodiment of the present invention, a method of managing computer process execution may include selecting a computer file prior to execution of the computer file, analyzing the selected computer file to determine at least one executable behavior, identifying the analyzed computer file as one of harmful or harmless, and disposing of the identified computer file as one of executable or non-executable, where the identified computer file is disposed as non-executable when identified as harmful.

In accordance with another embodiment of the present invention, a computer readable medium on which is stored a computer program for executing the following instructions may include selecting a computer file prior to execution of the computer file, analyzing the selected computer file to determine at least one executable behavior, identifying the analyzed computer file as one of harmful or harmless, and disposing of the identified computer file as one of executable or non-executable, where the identified computer file is disposed as non-executable when identified as harmful.

In yet another embodiment of the present invention, a pre-execution computer behavioral management system may include a memory and a processor. The memory is configured to store and retrieve information. The memory includes a rule database and at least one selected computer file containing at least one file behavior. The rule database includes at least one prohibited behavior for the computer file. The processor is configured to execute an algorithm to compare the unexecuted computer file behavior to the rule database to determine a match. The processor disables execution of the selected computer file if the identified file behavior matches a prohibited behavior in the rule database.

The scope of the present invention is defined by the claims, which are incorporated into this section by reference. A more complete understanding of embodiments of the present invention will be afforded to those skilled in the art, as well as a realization of additional advantages thereof, by a consideration of the following detailed description. Reference will be made to the appended sheets of drawings that will first be described briefly.

### BRIEF DESCRIPTION OF THE DRAWINGS

FIG. 1 shows an exemplary pre-execution behavior management flow, in accordance with an embodiment of the present invention.

FIG. 2 shows an exemplary network cluster including a computer and a file server that can communicate through an interconnection network, in accordance with an embodiment of the present invention.

FIG. 3 shows an exemplary computer file containing one or more behaviors, in accordance with an embodiment of the present invention.

FIG. 4 shows an exemplary rule database containing one or more prohibited behaviors, in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

Apparatuses, systems and methods are disclosed herein, in accordance with one or more embodiments of the present invention, that may provide for behavioral management of computer process execution by selectively prohibiting execution of a file capable of potentially malicious behaviors found within the file through heuristic analysis. The disclosed behavioral management system (BMS) may engage in a heuristic or investigative analysis on a file to identify what behaviors are enabled within the file. In this disclosure, any reference to the BMS may be drawn to one or more embodiments of the present invention. Also, the term heuristics includes an intelligent process by which defensive software examines potentially harmful software, termed malware. Malware can include any type of spying agent including traditional spyware, adware, and rootkits, for example.

Since a primary fault of traditional anti-virus software has been that they have relied almost exclusively on the detection of static, binary signatures, the traditional detection methods have removed the intelligence from the analysis. In this manner, many non-heuristic methods rely on static, dumb, or blind signatures. Malware files may also be encrypted, packed, or otherwise obfuscated so as to hide their true nature or capabilities. A suspect file may need to be decrypted, unpacked, or both during analysis. Heuristic modules may be used where each has a specific focus, including an emulation heuristic module configured to deal with emulation, a static analysis heuristic module configured to utilize static analysis, and a packed and/or encrypted file heuristic module configured to deal with obfuscated files. While emulation is typically more complex than static analysis, emulation may be more effective and have a lower risk. Conversely, static analysis offers advantages both in speed and in discovering anti-emulator tricks including mollasses code, fuse functionality, and improper operation code (OP code) handling. Other heuristic modules may also be used. As a learning or adapting system, heuristics can reduce false positives, as well as provide protection against classes of code attacks and families of malware.

In a selected file, the identified behaviors may be compared against a rule database that can be managed by a user or administrator so that particular rules or rule classes may be enabled or disabled. If a malicious behavior identified by a rule is found, and that behavior is disabled, then the file containing the malicious behavior will not be allowed to execute. In this manner, the malicious behavior may be identified prior to execution in order to have a higher capacity for blocking the unwanted behavior.

The BMS is designed to operate separately from an Operating System's underlying Access Control System and at the file analysis level instead of at the execution level, thereby preventing files with prohibited or harmful capabilities from being executed, rather then just attempting to prevent the prohibited capability from being used. This system may also operate with a checksum white list so that finer granularity and control may be given to the user or administrator of the computer system. Typically, the checksum values are protected cryptographically. A checksum white list is a table for relating the checksum values for various known-good files with at least one of the name, size, and location of the known-good file. More generally, a white listing system can include descriptions of approved executable files, even if the approved executables include one or more behaviors that would be prohibited by a rule or rule class. However, white listing has several limitations including the difficulty of keeping the white list current. Another attempt to protect against unknown malicious files may include the application of a generic, heuristic Anti-Virus System. Such systems are designed to look at run-time behaviors and judge files based on these behaviors. Such systems are designed to automatically analyze files to ascertain whether or not the file is malicious or harmful. In the BMS, boundaries are set for the capabilities of files as found through an investigative analysis of those files to allow a file to execute or not execute based on whether it has the potential for malicious behaviors, as so defined by the administrator of a system.

A Heuristic Anti-Virus (HAV) system typically differs from a BMS largely in the way they approach “maliciousness”. HAV systems are typically designed to look for maliciousness that identifies a suspect file as being malicious in a way similiar to fingerprint signature analysis systems. In this manner, a suspect file may be determined to be malicious or harmful if it is similiar to previously identified malicious files. For example, a HAV system might examine a suspect file and determine if the suspect file may attempt to scan a local disk system for email addresses and then attempt to create a client to send itself to these email addresses. This pattern of activity would be considered characteristically malicious. A BMS is typically not concerned with making distinctions about behavior based on previous observations of maliciousness in this manner, rather it allows for administrators to positively say, for instance, ‘do not allow for any executable file to scan the local disk system for email addresses’, or ‘do not allow for any executable to send itself out automatically over email channels’.

Using the ubiquitous Disc Operating System (DOS) filename extension paradigm, systems and methods according to one or more embodiments of the present invention examine executable code that may be contained within a directly executable program (*.EXE), a command file containing a memory image of executable program (*.COM), a Dynamic Linked Library (*.DLL), system driver file (*.SYS or *.DRV), cabinet file (*.CAB), a batch file (*.BAT), a binary file, a portable executable file Windows-32 file (*.EXE or *.SCR) or other executable file that may be executed either directly by a user or indirectly by calling out from a process. Executing processes within an Operating System (OS) generally depends on the underlying libraries contained in system files for a traditional OS. It is possible to hook into the process calls to these libraries, or the Application Programming Interface (API), to examine, allow, block, modify, and/or observe the process calls. Other mechanisms may allow bypassing of the API or a raw execution operation that does not require the use of APIs. Such mechanisms may be considered behaviors that are found through a variety of analysis techniques such as reversing back the raw binary code to the Assembly Language instruction codes, as in disassembly, and then comparing the disassembled code pieces with a database of similar code pieces.

According to one or more embodiments of the present invention, the systems and methods disclosed herein approach these problems differently than the previous attempts, by addressing them at the file level rather then at the system or process call level that may be further configurable by a rule or class database, where the database may be modified manually, by executing a script, or through an operator application. Rather then hooking into the OS or into every individual process in order to manage API calls, we examine an executable file for its inherent behaviors and then we either allow execution of this file or do not allow execution according to the potential behaviors discerned within the file. For example, an Import Table (IT) can be examined to determine if certain network libraries would be called or whether they can be called by this file. If an administrator does not wish for a user to execute any file with such capabilities then that file will be judged as “unacceptable” and the file will be denied execution rights and further disciplinary action may or may not be taken, such as a logging of the incident, or a destruction, or containment of the file in question.

Such systems which define access control based on whether a file actually performs the action or not are considered to be behaviorally based and are often referred to as “System Integrity” (SI) systems, or simply “Access Control” (AC) systems. These SI or AC systems are different from BMS because these systems require that a suspected malicious behavior is identified when it attempts to execute the suspected malicious behavior, as opposed to identifying the suspected malicious behavior before it can be executed through static, analytical discovery of the behavior found within the file.

One motivation for finding hidden behaviors within suspect files before the suspect file may be executed is because detection of a malicious behavior at runtime can often be difficult to ascertain. There are often many ways to surmount runtime detection systems, and the definition of “behavior” and particularly “malicious behavior” has become increasingly subtle. For example, it is not very difficult to require a system perform a check for privilege anytime a “delete” behavior is called, but it can be much more difficult to perform a check for a more complicated behavior such as ‘is a file scanning the system for email addresses’ and intercept that type of behavior before it executes. Alternatively, a malicious behavior such as ‘an executable file setting up the system to format itself on reboot’ might be a more illuminating behavior a system would want to stop.

In another example, an administrator or user may not want files to execute that have the capability to more specifically perform certain behaviors, such as to operate as a network client or server. Alternatively, the system administrator may not permit a user to execute files that have the capability within them to inject into other processes or read another process's memory or in any way spy or control another process. An administrator may not permit executables to overcome, or surmount privilege powers or to write to disk, write to the registry, or to access the disk or the registry in certain ways. Systems that operate on the hooking level cannot prevent behavior that is disguised in some manner to overcome the protection of said systems, as discussed above. As described, the BMS may be designed to supersede the Operating Systems privilege system, enhancing and further securing its value and thereby increasing the entire security of the system. Unlike the underlying privilege system of the Operating System, a wider range of behavioral checks are allowed, which may be expanded by using a configurable rules database enabling a wide variety of capabilities that may be used and expanded by a vendor, administrator, and user of the system.

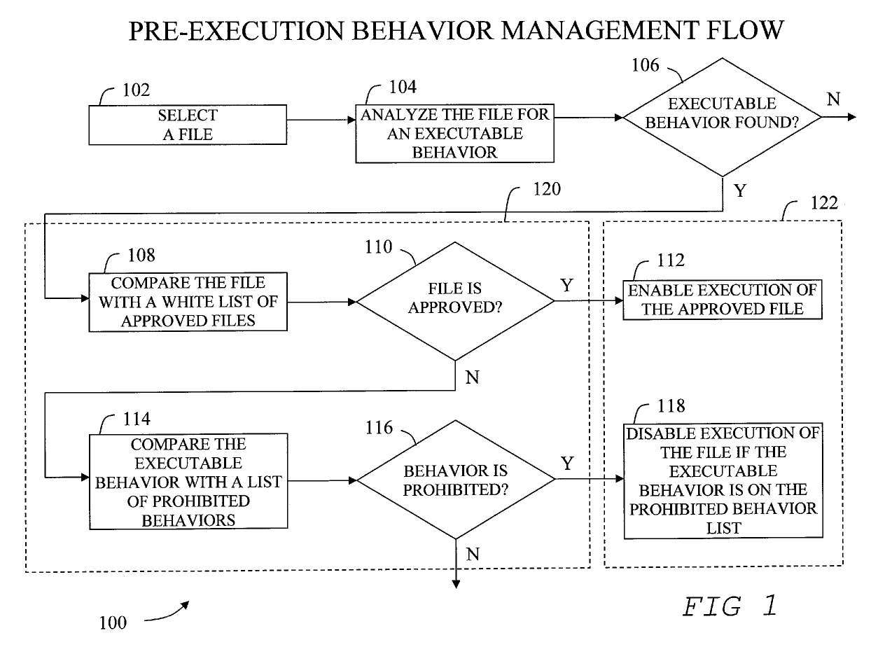

FIG. 1 shows a pre-execution behavior management flow 100 that may include one or more of the following operations, including selecting a file in operation 102, analyzing the selected file for an executable behavior in operation 104, and determining whether an executable behavior is found in the selected file in operation 106. If no executable behavior is found in operation 106, the result of the determination is ‘N’ and flow 100 terminates. However, if an executable behavior is found in operation 106, the result of the determination is ‘Y’ and flow 100 continues with comparing the selected file with a list of approved files in operation 108, and determining whether the selected file is approved in operation 110. When the selected file includes an executable behavior and is approved, the result of the determination is ‘Y’, and flow 100 continues with enabling the execution of the approved file in operation 112, and flow 100 terminates. However, if the selected file is not approved, the result of the determination is ‘N’, and flow 100 continues with comparing the executable behavior with a list of prohibited behaviors on a prohibited behavior list in operation 114, and determining if the executable behavior is prohibited in operation 116.

If the detected behavior is prohibited, the result of the determination is ‘Y’, and flow 100 continues with disabling execution of the selected file in operation 118. Disabling execution of the selected file may include setting a do-not-run bit on the file or file record itself, removing a necessary executable attribute of the selected file, listing the selected file on a do-no-run list, or some other mechanism to prevent execution of the selected file. The detected behavior is prohibited if the executable behavior found in the selected file is found on the prohibited behavior list. If the detected behavior is not prohibited, the result of the determination is ‘No’, and flow 100 terminates. Flow 100 can be repeated for any number of selected files. In this manner, operations 108, 110, 114, and 116 may be grouped into identifying the analyzed computer file in operation 120, while operations 112 and 118 may be grouped into disposing of the identified computer file in operation 122. In general terms, the operations of comparing the file with a white list of approved file in operation 108 and/or comparing the executable behavior with a list of prohibited behaviors in operation 114 identifies the selected file (i.e. provides an identity of the selected file) as harmful or harmless prior to execution of the selected file.

Similarly, the operations of enabling execution of the approved file in operation 112 and/or disabling the execution of the selected file in operation 118 provides a disposition of (i.e. disposes of) the selected file as executable or non-executable. If a selected file is designated as non-executable, the entire selected file may be non-executable.

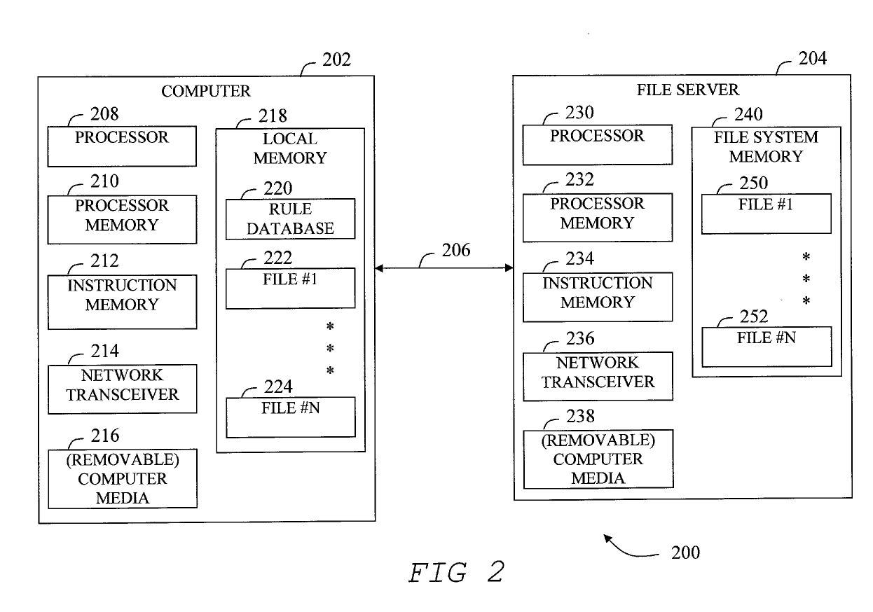

FIG. 2 shows an exemplary network cluster 200 showing a computer 202 and a file server 204 that can communicate through an interconnection network 206, in accordance with an embodiment of the present invention. Computer 202 may be a general-purpose computer system such as a desktop, laptop, or rack-mounted system, and may include a processor 208, a processor memory 210, an instruction memory 212, a network transceiver 214, a (removable) computer media 216 configured to store and receive data and/or instructions, and a local memory 218 which can include a disc memory. Processor 208 can be any suitably programmed computer processor, such as a microprocessor, that can execute instructions and operate on data, stored within a built-in or external processor memory 210 and/or instruction memory 212. The instructions and/or data may comprise an algorithm to implement some or all of the pre-execution behavior management flow 100, as discussed in reference to FIG. 1.

File server 204 may be a general-purpose computer system that may be used to receive, store, and/or distribute computer files. The file server 204 may include a general-purpose computer system such as a desktop, laptop, or rack-mounted system, and may include a processor 230, a processor memory 232, an instruction memory 234, a network transceiver 236, a (removable) computer media 238 configured to store and receive data and/or instructions, and a file system memory 240 which can include a disc memory. The file system memory 240 can store and retrieve one or more computer files. Processor 230 can be any suitably programmed computer processor, such as a microprocessor, that can execute instructions and operate on data, stored within a built-in or external processor memory 232 and/or instruction memory 234.

Computer 202 may communicate with file server 204 over interconnection network 206 to perform one or more of the operations associated with flow 100 so that the analysis is performed remotely. In this manner, a selected file on a remote computer system may be analyzed to determine if it is harmful or harmless prior to execution of the selected file. Alternatively, the analysis may be performed locally on the file server 204. In this manner, either computer 202 or file server 204 may comprise a pre-execution computer behavioral management system configured to detect malicious executable behavior prior to execution. The disposition of a selected computer file may be stored in memory systems (210, 212, 216, and 218) associated with computer 202 and/or may be stored in memory systems (232, 234, 238, and 240) associated with file system 204.

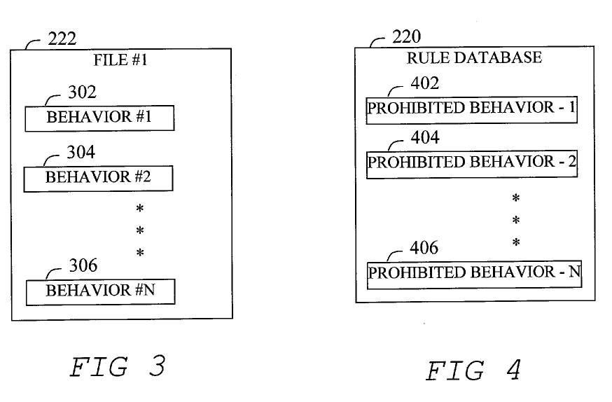

FIG. 3 shows an exemplary computer file 222 containing one or more executable behaviors (302-306), in accordance with an embodiment of the present invention. Each behavior includes the execution of a particular command or series of commands to move, store, or change information either in computer 202 or another network node such as file server 204. The executable behaviors can include any operation that reads, writes, or moves data or instructions within a computer system or over a communications network.

FIG. 4 shows an exemplary rule database 220 containing information related to one or more prohibited behaviors (402-406), in accordance with an embodiment of the present invention. When a file behavior (302, 304) matches a prohibited behavior (402-408) execution of the selected file 222 is disabled.

Although the invention has been described with respect to particular embodiments, these descriptions are only examples of the invention's application and should not be taken as limitations. Accordingly, the scope of the invention is defined only by the following claims.

I claim:

1. A method of managing computer process execution, comprising the operations of:
selecting a computer file prior to execution of the computer file;
analyzing the selected computer file to determine at least one executable behavior;
identifying the analyzed computer file as one of harmful or harmless; and
disposing of the identified computer file as one of executable or non-executable, the identified computer file being disposed as non-executable when identified as harmful.

2. The method of claim 1, wherein the operation of selecting a computer file includes accessing an application programming interface.

3. The method of claim 1, wherein the selected file is at least one of a directly executable program, a command file, a dynamic linked library file, a system driver file, a cabinet file, a batch file, and a binary file.

4. The method of claim 1, wherein the operation of analyzing the executable file includes at least one of disassembling the executable code, decrypting at least a portion of the selected file, and unpacking at least a portion of the selected file.

5. The method of claim 1, wherein the selected file is located on a remote computer system.

6. The method of claim 1, wherein the operation of identifying the analyzed computer file further comprises the operation of:
comparing the selected file with a list of approved files.

7. The method of claim 6, wherein the list of approved files is included in a white list based on checksum values.

8. The method of claim 7, wherein the while list checksum values are cryptographically protected.

9. The method of claim 6, wherein the operation of disposing of the identified computer file further comprises the operation of:
enabling the execution of the selected file when the selected file is on the list of approved files.

10. The method of claim 1, wherein the operation of identifying the analyzed computer file further comprises the operation of:
comparing the executable behavior to a list of prohibited behaviors in a prohibited behavior database.

11. The method of claim 10, wherein the operation of disposing of the identified computer file further comprises the operation of:
disabling the execution of the identified computer file when the executable behavior is listed in the prohibited behavior database.

12. A computer readable medium on which is stored a computer program for executing the following instructions:
selecting a computer file prior to execution of the computer file;
analyzing the selected computer file to determine at least one executable behavior;
identifying the analyzed computer file as one of harmful or harmless; and
disposing of the identified computer file as one of executable or non-executable, the identified computer file being disposed as non-executable when identified as harmful.

13. The medium of claim 12, wherein the operation of identifying the analyzed computer file further comprises the operation of:
comparing the executable behavior to a list of prohibited behaviors in a prohibited behavior database.

14. The medium of claim 13, wherein the operation of disposing of the identified computer file further comprises the operation of:
disabling the execution of the identified computer file when the executable behavior is listed in the prohibited behavior database.

15. The medium of claim 12, wherein at least one of the selected computer file and the prohibited behaviors is found through heuristic analysis.

16. A pre-execution computer behavioral management system, comprising:
a memory, the memory being configured to store and retrieve information, the memory including a rule database and at least one selected computer file containing at least one file behavior, the rule database include at least one prohibited behavior for the computer file; and
a processor, the processor being configured to execute an algorithm to compare the unexecuted computer file behavior to the rule database to determine a match, the processor disabling execution of the selected computer file if the identified file behavior matches a prohibited behavior in the rule database.

17. The system of claim 16, wherein at least one of the selected computer file and the prohibited behaviors is found through heuristic analysis.

18. The system of claim 16, wherein the computer file containing at least one file behavior is located on a remote computer system.

19. The system of claim 16, wherein the algorithm includes operations comprising:
selecting a computer file prior to execution of the computer file;
analyzing the selected computer file to determine at least one executable behavior;
identifying the analyzed computer file as one of harmful or harmless; and
disposing of the identified computer file as one of executable or non-executable, the identified computer file being disposed as non-executable when identified as harmful.

20. The system of claim 19, wherein the algorithm includes operations comprising:
comparing the executable behavior to a list of prohibited behaviors in a prohibited behavior database; and
disabling the execution of the selected file when the executable behavior is listed in the prohibited behavior database.
